(19) United States
(12) Patent Application Publication
(10) Pub. No.: US 2026/0133995 A1
(43) Pub. Date: May 14, 2026

(54) DATA ANALYTICS PRUNING

(71) Applicant: Home Depot Product Authority, LLC, Atlanta, GA (US)

(72) Inventors: Yanxin Ye, Atlanta, GA (US); Yaping Zhang, Atlanta, GA (US); Vigneshwar Manokaran, Atlanta, GA (US); Rajeev Natarajan, Atlanta, GA (US)

(21) Appl. No.: 18/944,601

(22) Filed: Nov. 12, 2024

(51) Int. Cl. G06F 16/28; G06F 16/245

(52) U.S. Cl. CPC G06F 16/285; G06F 16/245

(57) ABSTRACT

A system or method for identifying key drivers of change in a dataset based on a metric includes obtaining a first dataset including a plurality of data objects having feature values for a plurality of features, pruning one or more data objects from the first dataset based on feature values associated with each data object and the metric and determining a second dataset including a set of data objects having associated therewith feature values for the plurality of features, determining, based on the metric, a candidate feature in the second dataset, identifying, based on a threshold value, a candidate feature value representative of a key driver of change from feature values associated with the candidate feature in the second dataset, the candidate feature value being representative of the key driver of the first dataset as output in response to the query, and the metric including the threshold value.

### FIELD

The present disclosure relates to the field of data analytics. More particularly, to identifying key drivers using data analytics pruning.

### BACKGROUND

Data analytics techniques can generally be applied to a dataset using a computing device of an entity for different applications such as, for example, to determine a key driver of the data that influences a metric. The key driver of the dataset can be leveraged by an entity to, for example, perform one or more actions to further an entity's business objectives. The data analytics techniques can be applied to datasets ranging in size from a few data points to hundreds, thousands, or millions of data points, each data point can correspond to a feature value representative of a characteristic such as, for example, a category or subclass, or the feature value can be representative of a numerical value. The dataset can be processed using the data analytics techniques to enable the entity to make some decision based on the data.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a block diagram of an example system, according to some embodiments.

FIG. 2 is a flow diagram of an example method for identifying a key driver of a dataset, according to some embodiments.

FIG. 3 is a block diagram of an example system for performing the method of FIG. 2, according to some embodiments.

FIG. 4 is a flow diagram of an example method for pruning feature values in a dataset, according to some embodiments.

FIG. 5 is a graphical diagram of an example dataset corresponding to a search space, according to some embodiments.

FIG. 6 is a flow diagram of an example method for pruning feature values in a dataset, according to some embodiments.

FIG. 7 is a graphical diagram of an example dataset corresponding to the search space, according to some embodiments.

FIG. 8 is a flow diagram of an example method for identifying the key driver in the dataset, according to some embodiments.

FIG. 9 is a graphical diagram of an example dataset, according to some embodiments.

FIG. 10 is a graphical diagram of an example dataset, according to some embodiments.

FIG. 11 is a flow diagram of an example method for pruning features in a dataset, according to some embodiments.

FIG. 12 is a block diagram of an example computing system, according to some embodiments.

### DETAILED DESCRIPTION

A computing device can apply one or more data analytics techniques and/or data analytics algorithms using a model to leverage data for different applications including, for example, identifying key drivers based on a metric, identifying data patterns, determining contributors or non-contributors, and determining predictions, among other purposes. The one or more data analytics techniques can be applied to a dataset ranging in size from a few data points to hundreds, thousands, or millions of data points. Each data point can correspond to, for example, a categorical feature value or a numerical feature value.

Various embodiments of the present disclosure relate to systems, methods, and computer program products for pruning a dataset and identifying a key driver in the dataset based on a metric. A computing system or networked computing device can be utilized to identify one or more key drivers of a dataset based on the metric. The computing device can include a model that can apply one or more model techniques and/or model algorithms to the data to identify the one or more key drivers based on the metric.

As used herein, the term “metric” can refer to a target objective that can be defined by a user and can be utilized to compare actual performance against a pre-defined goal. For example, the metric can be defined an entity to determine insights from data and to determine one or more actions to further their business objectives based on the insights. The metric can correspond to a quantitative value or a quantitative value that can be utilized to then determine the actual performance against the metric in a dataset.

As used herein, the term “key driver” can refer to a factor (e.g., feature value) that has a significant impact on a variable's outcome (e.g., metric). The key driver can correspond to a single feature value or a combination of feature values that influences the metric in the dataset. The key driver can correspond to a quantitative value or a qualitative value. In an example, the machine learning model can determine the key driver corresponds to a single feature value representative of a certain product in a merchant's inventory that is sold by the merchant and that is driving a growth in revenue for the merchant during a defined time period. In another example, the key driver corresponds to an electronic policy associated with a system of an entity that is driving a decline in completed electronic transactions from users interacting with a networked computing system of the entity.

To identify the key driver of the dataset, the model can be configured to perform operations including pruning a set of feature values from the dataset, performing a search to identify a top feature value corresponding to a key driver of the dataset, filtering out a set of feature values from the dataset based on the identified top feature value, and pruning the set of feature values from the dataset based on the identified top feature value. In addition, the pruning of features from the dataset can be based on a threshold. In some embodiments, the threshold can be a defined metric that is defined by the entity.

In addition, the key driver of the dataset can be a single factor or a combination of factors. Accordingly, the embodiments of the present disclosure can determine the key driver of the dataset by analyzing the different possible combinations of features in the dataset based on the metric.

Embodiments of the present disclosure provide one or more improvements over current data analytics techniques including converging on solutions with improved efficiency and accuracy, identifying the feature corresponding to the key driver of the dataset at a granular level, reducing an amount of manual or supervised input needed to process the data, and providing a machine learning model that can be utilized by various different users and that can be applied to different datasets to identify the key driver of the dataset based on the metric, and thus to determine insights using the dataset. For example, the model can identify one or more key drivers of a dataset that includes data from 200 business units of an entity and based on 7 metrics.

The embodiments of the present disclosure can identify key drivers of the dataset using the model with improved efficiency over other known approaches by pruning features from the dataset before determining the key driver. In this regard, the embodiments of the present disclosure can reduce a number of searches that may need to be performed to identify the key driver of a dataset as a function of reducing the number of features in the dataset. In an example, the machine learning model can reduce the number of features in the dataset from 11,138 features to 861 features, thereby reducing the number of searches needed to be performed to determine the key driver of the dataset from 2.30×10¹⁶ searches to 6,876 searches. In some embodiments, the machine learning model can identify features corresponding to non-contributors for pruning from their corresponding feature values and based on the metric. In other embodiments, the model can identify features corresponding to contributors for pruning because of their association with features corresponding to non-contributors and based on the metric.

Once the features are pruned from the dataset, one or more search algorithms can be utilized by the model to identify a first feature value corresponding to the key driver of the dataset. In addition, in some embodiments, based on a hierarchy of the identified first feature value, the model can prune one or more additional features from the dataset having a higher hierarchy than the hierarchy of the identified first feature value. Furthermore, if the identified first feature value does not meet the threshold metric, the machine learning model can utilize the one or more search algorithms to identify a second feature value, the key driver thereby including the first feature value and the second feature value, and so forth until the identified features meets the threshold metric. For example, pruning features from the dataset such that the the number of features from 2.30×10¹⁶ searches to 6,876 searches.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

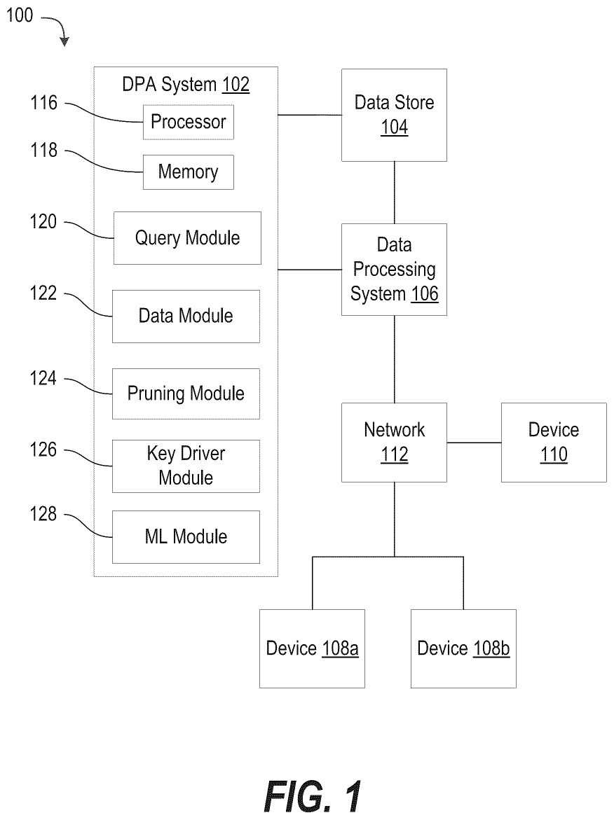

FIG. 1 is a block diagram of an example system 100 for identifying key drivers in a dataset by pruning data based on a metric, according to some embodiments.

The system 100 can include a data pruning analytics (DPA) system 102, a data source 104, a data processing system 106, a plurality of computing devices 108 (two such computing devices 108a, 108b are shown), and computing device 110. The data source 104 can include, for example, inventory data, vendor data, electronic transaction data of data processing system 106, among other types of data.

The computing devices 108 can be in electronic communication with DPA system 102, data processing system 106, computing device 110, with each other, or any combination thereof, over network 112 or some other network. In an example, the computing devices 108 can be associated with a respective business unit of an entity of system 100 and performing electronic transactions on data processing system 106 through network 112. The computing device 110 can be in electronic communication with DPA system 102, data processing system 106, computing devices 108, or any combination thereof, over network 112 or some other network. For example, computing device 110 can be associated with a user that is sending a query to DPA system 102 to identify a key driver of data based on one or more defined metrics. The DPA system 102, data source 104, and data processing system 106 can also all be in electronic communication with each other via the network 112 and/or another network.

The DPA system 102 can include a processor 116 and a non-transitory, computer readable memory 118 that contains instructions that, when executed by the processor 116, cause the DPA system 102 to perform one or more of the steps, processes, methods, operations, etc. described herein with respect to DPA system 102. In some embodiments, the DPA system 102 can include a computer-program product having stored thereon instructions that can be executable by the processor 116 to perform the one or more of the steps, processes, methods, operations. etc. described herein with respect to DPA system 102. In some embodiments, the DPA system 102 can include one or more functional modules embodied in the memory. Referring to FIG. 1, the functional modules of DPA system 102 can include a query module 120, a data module 122, a pruning module 124, a key driver module 126, and a machine learning module 128.

The present disclosure refers to accounts, business units, vendors, merchants, users, service providers, and electronic transactions and other electronic activity. Such accounts can be accounts common to a particular entity, a particular business unit, a particular service provider, a particular vendor, a particular network, a particular electronic activity processor, etc. In one example, the accounts can be accounts with data processing system 106, and the accounts can be associated with different business units of an entity performing electronic transactions using data processing system 106. In another example, the accounts can be associated with different merchants performing electronic transactions using data processing system 106. In yet another example, the accounts can be associated with vendors performing electronic transactions using data processing system 106. The electronic transactions and other activity can be transactions processed by, or other activity in or through, data processing system 106, and/or transactions and activity outside of the data processing system 106. Although this disclosure refers to transactions as context for the novel methods and systems, it should be understood that such methods and systems can be applied to or in the context of a wide variety of computing actions, some of which cannot be considered transactions. For example, where past transactions are considered herein, past computing actions can more broadly be considered. Similarly, where present transactions are responded to herein, present computing actions can more broadly be responded to.

DPA system 102 can include query module 120. The query module 120 can be configured to receive, as input, a query such as, for example, from computing devices 108. The query can correspond to a request to identify a key driver of change in a dataset based on a defined metric. In some embodiments, the query can include the dataset for processing. In other embodiments, the query can include one or more parameters for the dataset to be processed by the one or more functional modules of DPA system 102, and the DPA system 102 can obtain the data from a data store such as, for example, from memory 118 or data source 104 based on the one or more parameters. In an example, the data can include feature values from across 8 different categories and can include electronic transactions with data processing system 106 performed by computing devices computing devices 108 associated with 100 different retail locations of an entity of system 100.

The query can include a defined metric. The metric can define an objective for processing a dataset and for determining a key driver of the dataset. That is, the DPA system 102 can determine the key driver from the features of the dataset that is a top contributor towards the metric. In this regard, the one or more functional modules of DPA system 102 can be configured to perform the steps, processes, methods, operations, etc., described herein based on the metric. In an example, the metric can be a decline in completed electronic transactions and the corresponding decline in revenue. In another example, the metric can be an increase in completed electronic transactions by computing devices 108. In some embodiments, the query can include a plurality of metrics.

DPA system 102 can include data module 122. Data module 122 can be configured to obtain data from a data source based on the query. The data can be obtained by data module 122 based on one or more parameters of the query. For example, the DPA system 102 can obtain the data from data source 104. In some embodiments, the data module 122 can obtain the data from the data source based on the one or more parameters of the query, and the data module 122 can generate the dataset for processing by the one or more other functional modules of DPA system 102.

The data obtained by data module 122 or DPA system 102 can include categorical data, numerical data, or both categorical data and numerical data. Categorical data can correspond to qualitative data represented by, for example, text data, and can be used to describe characteristics of a population. Numerical data can correspond to quantitative data represented by numbers and can be used to, for example, measure a certain characteristic or measure changes in value over time. In some embodiments, the data can include image data.

The data obtained by data module 122 or DPA system 102 can include a plurality of data objects having associated therewith feature values for a plurality of features. The data can be, for example, associated with data processing system 106 or system 100. In some embodiments, the dataset can include a plurality of features including a first set of features and a second set of features associated with DPA system 102 and/or data processing system 106. The first set of features can include one or more categorical features. In some embodiments, the first set of features can include, but is not limited to, department, class, location, vendor, product, account, user, user behavior, user interaction, policy, other categories associated with data processing system 106 or system 100, or any combination thereof. In a non-limiting example, the data obtained by data module 122 includes a plurality of feature values including feature values for a plurality of features corresponding to different departments including an appliance department, lumber department, garden department, plumbing department, lighting department, electrical department, etc. In another example, the dataset can include a plurality of feature values for a plurality of features corresponding to a plurality of departments including an inventory department, warehouse department, procurement department, finance department, sales department, marketing department, human resources department, etc., or any combination thereof. In some embodiments, the plurality of features can include one or more subclasses. For example, the dataset can include a region subclass and a market subclass associated with retail locations of an entity of system 100.

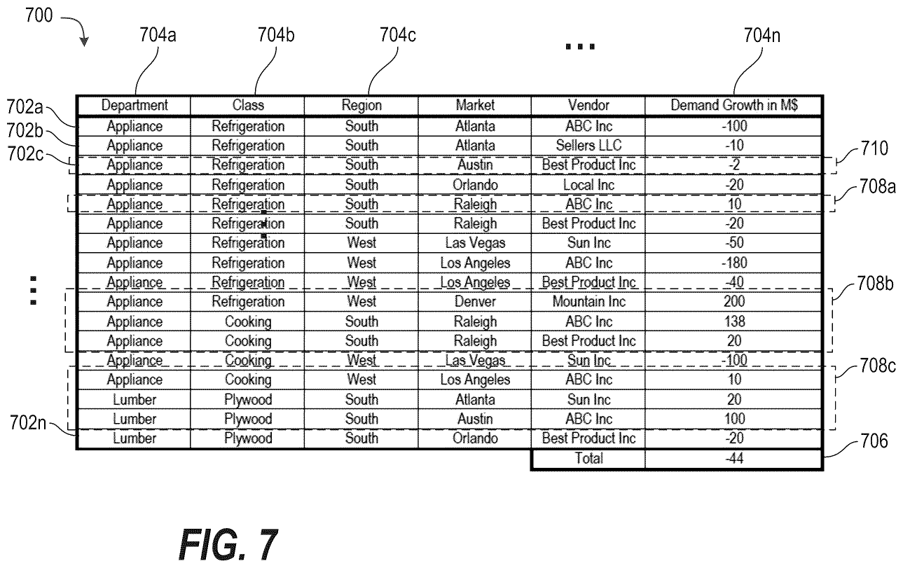

The data obtained by data module 122 or DPA system 102 can include a second set of features. The second set of features can include one or more numerical features associated with DPA system 102 and/or data processing system 106. In some embodiments, the second set of features can include, for example, unit cost, revenue, demand growth, etc., which can be utilized by the DPA system 102 to identify the key driver of the data. In a non-limiting example, as shown in FIG. 7, the categories of a dataset can include department, class, region, market, vendor, and demand growth, during a time period as defined by the one or more parameters of the query.

According to some embodiments, the data obtained by data module 122 or DPA system 102 can include a plurality of objects, and each object can include a plurality of features associated therewith. In addition, each object can include a feature value associated with each feature of the plurality of feature values. In some embodiments, each object can have a first set of features, a second set of features, or both associated therewith. In this regard, the feature values associated with each object of the plurality of objects can be arranged according to feature such as, for example, in a data table.

It is to be appreciated that one or more functional modules of DPA system 102 can process the dataset including the plurality of feature values for the plurality of features. The plurality of features of the first dataset as described herein are exemplary and not intended to be limiting. Accordingly, the one or more functional modules of DPA system 102 can be utilized to identify one or more features values corresponding to key drivers of a dataset from any of a plurality of different features including categorical features, numerical features, other types of feature data, or any combination thereof, in accordance with the present disclosure.

DPA system 102 includes pruning module 124. Pruning module 124 can be configured to obtain a first dataset and prune features from the first dataset based on the metric and determine a second dataset. In some embodiments, the pruning module 124 can prune one or more data objects of the plurality of data objects from the first dataset based on comparing feature values associated with each of the plurality of data objects to the metric. In some embodiments, pruning the features from the first dataset can include identifying feature values in the first dataset as corresponding to at least one of contributors or non-contributors of the metric, and filtering out data objects corresponding to at least one of the contributors or non-contributors of the metric from the plurality of data objects of the first dataset. In some embodiments, pruning the features from the first dataset can include determining the second dataset including a first set of data objects of the plurality of data objects having associated therewith feature values for the plurality of features. In some embodiments, the second dataset may not include the data objects associated with the one or more first feature values. In some embodiments, the second dataset may not include the data objects associated with the one or more second feature values. In some embodiments, the second dataset may not include the data objects associated with the one or more first feature values and the one or more second feature values. In this regard, the pruning module 124 can be configured to prune one or more features from datasets. By pruning the one or more features from the dataset, the pruning module 124 can reduce the number of features that can be searched by the key driver module 126 for determining a feature value corresponding to a key driver of the dataset based on the metric. In other embodiments, pruning the data objects from the first dataset based on the feature values associated therewith can include extracting the data objects associated with the feature values from the first dataset such that the first dataset is transformed into a second dataset not including the pruned features.

DPA system 102 includes key driver module 126. Key driver module 126 can be configured to determine a candidate feature of the plurality of features in the second dataset and identify a candidate feature value representative of the key driver of the second dataset based on the metric. In some embodiments, the key driver module 126 can identify the candidate feature value corresponding to the key driver from the remaining features of the second dataset based on a threshold value. In some embodiments, the metric can include the threshold value. In other embodiments, the key driver module 126 can determine the threshold value based on the metric. In some embodiments, the key driver can be a feature value common to one or more data points of the candidate feature (e.g., column) of the second dataset, and the common feature value can correspond to the top factor in the second dataset that is driving the change in the first dataset as determined based on the metric. For example, the first dataset can correspond to historical electronic transaction data of data processing system 106 during the past year, and the key driver module 126 can determine a feature value common to a certain merchant account that performs electronic transactions for goods and/or services offered by the merchant is a key driver of a decline in demand growth at data processing system 106 and/or system 100.

According to some embodiments, identifying the candidate feature value can further include the key driver module 126 being configured to identify a feature value associated with each data object for the candidate feature in the second dataset, classifying each data object of the first set of data objects based on the feature value associated with each data object of the first set of data objects for the candidate feature, and filtering out one or more data objects from the first set of data objects of the second dataset based on the candidate feature value. In some embodiments, identifying the candidate feature value can further include determining a third dataset. In some embodiments, the third dataset can include a second set of data objects having associated therewith feature values for the plurality of features.

In some embodiments, identifying the candidate feature value can further include the key driver module 126 being configured to group the data to enable identifying the feature value corresponding to the key driver. Grouping the data can include grouping data objects based on having at least one common feature value at a feature (e.g., column). In some embodiments, grouping the data can include grouping data objects based on having a common feature value at the candidate feature. The key driver module 126 can then be configured to identify the candidate feature value corresponding to the key driver of the dataset from the one or more groups based on the metric.

In some embodiments, the key driver module 126 can be configured to compare the identified candidate feature value to the threshold value. In response to the identified candidate feature value exceeding the threshold value, the key driver module 126 can be configured send the candidate feature value as being representative of the key drive of the first dataset as output. If the key driver of the dataset is a single feature value, then the key driver module 126 can provide the identified feature value as output. In some embodiments, however, the key driver of the dataset can include a combination of feature values. In this regard, the key driver module 126 or DPA system 102 can determine if the identified candidate feature value fully explains the metric by comparing the candidate feature value to the threshold or by comparing one or more feature values for another feature that are associated with the data objects having the candidate feature value associated therewith. In some embodiments, for example, a dataset can include one or more numerical feature values associated with each categorical feature value or with each set of categorical feature values (e.g., data rows) in the dataset, and the sum of the numerical feature values associated with the feature value determined to be a key driver of the dataset can be less than a threshold value determined based on the metric. In an example, a single feature value determined to be a key driver of the dataset can explain 25% of the threshold. In another example, a single feature value determined to be a key driver of the dataset can explain 100% of the threshold.

In response to determining that the candidate feature value identified by key driver module 126 does not meet the threshold, the key driver module 126 can be configured to identify one or more other features values corresponding to the key driver of the first dataset until the threshold value is met or exceeded. In some embodiments, in response to the identified candidate feature value not exceeding the threshold value, the key driver module 126 can be configured to determine at least one additional candidate feature value that is representative of the key driver of the first dataset from the remaining features and feature values of the second dataset. In some embodiments, to determine the at least one additional candidate feature value, the key driver module 126 can be configured to filter out the one or more feature values having values corresponding to the candidate feature value previously identified as being representative of the key driver from the second dataset. In some embodiments, to determine the at least one additional candidate feature value, the key driver module 126 can be configured to filter out the data objects associated with the one or more feature values having values corresponding to the candidate feature value previously identified as being representative of the key driver from the second dataset.

In addition, to determine the at least one additional candidate feature value, the key driver module 126 can be configured to further refine the second dataset in response to determining the candidate feature value is below the threshold value and identifying at least one additional candidate feature value as being representative of the key drive from the further refined second dataset based on comparing the at least one additional candidate feature value and the previously identified candidate feature value to the threshold level and the metric. In some embodiments, further refining the second dataset can include filtering the feature values previously identified as having the candidate feature value that is representative of the key driver. In some embodiments, further refining the second dataset can include the key driver module 126 or one or more other modules of the DPA system 102 repeating one or more operations to identify the at least one additional candidate. In some embodiments, the one or more operations can include pruning data objects based on the features associated therewith corresponding to at least one of non-contributors or contributors of the metric, determining the candidate feature, identifying the at least one additional candidate feature representative of the key driver from the feature values associated with the identified candidate feature in the refined second dataset. In this regard, the key driver module 126 can be configured to repeat at least one of the pruning, determining, or identifying steps until the identified candidate feature value and the at least one additional candidate feature values exceeds the metric or the threshold value. For example, the key driver of the change in the first dataset can correspond to a first feature value, a second feature value, and a third feature value, that in combination exceeds the defined metric. In an example, a first feature value identified by key driver module 126 can explain 70% of a threshold, and a second feature value identified by key driver module 126 can explain at least a remaining 30% of the threshold.

In some embodiments, the one or more operations can further include determining the respective hierarchy of each feature of the plurality of features, identifying one or more features of the plurality of features having a higher hierarchy than the at least one additional candidate feature, and filtering out the one or more features having the higher hierarchy than the at least one additional candidate feature.

In addition, in some embodiments, the key driver module 126 can be configured to further reduce the dataset. In some embodiments, the key driver module 126 can further reduce the dataset by filtering out one or more feature values from the datasets having values corresponding to null values from the dataset. The key driver module 126 can be configured to perform this operation at any point during the processing to enable reducing the size of the dataset.

The key driver module 126 can be configured to identify the candidate feature value (including the at least one additional candidate feature values) from the dataset by applying a search algorithm of any of a plurality of search algorithms to the dataset. In some embodiments, the key driver module 126 can be configured to identify the candidate feature value from the second dataset by applying one or more of a plurality of search algorithms to the dataset. The plurality of search algorithms can include, for example, supervised, unsupervised, brute force search, greedy search, linear regression, logistic regression, support vector machines, random forest, K nearest neighbors, naïve bayes, neural networks, clustering, means clustering, reinforcement learning, decision tree, gradient boosting, dimensionality reduction, adaptive boosting, decision trees regression, Bayesian algorithms, breadth first search, classification, or graphs, among other algorithms. In some embodiments, the key driver module 126 can be configured to identify the candidate feature value from the second dataset by applying a search algorithm of the plurality of search algorithms to the dataset. In some embodiments, the key driver module 126 can be configured to identify the candidate feature value from the second dataset by applying a greedy search algorithm to the dataset.

The DPA system 102 includes machine learning (ML) module 128. ML module 128 can include a machine learning model configured to operate in conjunction with one or more other functional modules of DPA system 102 to enable further investigation of the key drivers in accordance with the present disclosure. In this regard, the model can utilize the one or more machine learning techniques and/or machine learning algorithms to perform one or more operations including, but not limited to, obtain the query, determine one or more parameters of the query, determine a metric of the query, determine a threshold based on the metric, or any combination thereof, among other operations.

In addition, the model can utilize the one or more machine learning techniques and/or machine learning algorithms to perform one or more other operations based on the metric including, but not limited to, obtain data including a plurality of features from the data source, classify the features of the dataset.

According to some embodiments, the one or more machine learning techniques and/or machine learning algorithms utilized by the machine learning model can include, for example, natural language processing (NLP) techniques to understand a text data and a context of the text data. The machine learning model can be configured to obtain data from a data source based on the query. In some embodiments, the machine learning model can be configured to utilize the one or more machine learning techniques and/or machine learning algorithms to determine the one or more parameters for obtaining data from the data source based on the query. In other embodiments, the machine learning model can be configured to utilize the one or more machine learning techniques and/or machine learning algorithms to determine the one or more parameters for obtaining data from the data source based on a context of the query.

In some embodiments, the machine learning model can be configured to utilize the one or more machine learning techniques and/or machine learning algorithms to determine the metric for identifying the key driver of the dataset based on the query. In other embodiments, the machine learning model can be configured to utilize the one or more machine learning techniques and/or machine learning algorithms to determine a metric for identifying the key driver of the dataset based on a context of the query.

The machine learning model can also be configured to search a dataset to identify the key driver based on the metric. In some embodiments, the machine learning model can be configured to utilize the one or more machine learning techniques and/or machine learning algorithms to search the dataset and identify the top feature value corresponding to the key driver of the dataset based on the text data and the metric. In other embodiments, the machine learning model can be configured to utilize the one or more machine learning techniques and/or machine learning algorithms to search the dataset and identify the top feature value corresponding to the key driver of the dataset based on the context of the text data and the metric. In some embodiments, the machine learning model can be configured to utilize the one or more machine learning techniques and/or machine learning algorithms to search the dataset and identify the combination of top feature values corresponding to the key driver of the dataset based on the text data and the metric. In some embodiments, the machine learning model can include a greedy search algorithm configured to identify the feature value(s) corresponding to the key driver of the dataset.

As used herein, the term “greedy search algorithm” refers to a method for determining a solution by working in stages, considering one input element at a time at a stage, and choosing the best option based on the current situation at each stage so as to provide locally optimal solutions that may be close to a best overall solution within a certain time period.

The machine learning model can be trained using a training dataset. The training data can include, for example, at least one of supervised data, unsupervised data, both supervised and unsupervised data, among other data types. The training data can be used to train weights and biases of a model of the DPA system 102. In addition, the training dataset can include, for example, streaming data, batch data, previous iterations of training data, other data, or any combination thereof. In some embodiments, the machine learning model can be initially trained using a training dataset and then subsequent iterations of the machine learning model can be trained using, for example, the training data, other training data, streamlining data, batch data, feedback data, historical training data, among other types of data.

The streaming data can correspond to electronic activity of computing devices on data processing system 106 and/or DPA system 102 such as, for example, by computing devices 108, device 110, or both. The streaming data can include feedback data generated in response to a user's interactions with the feature values corresponding to the key driver provided as output by DPA system 102 and sent to the user computing device such as, for example, computing device 110 in response to the query. The batch data can include, for example, profile data, account data, historical streaming data, user sentiment data, user behavior data, inferencing data, inventory data, among other types of data.

It is noted that systems and/or associated controllers, servers, or machine learning components 128 herein can comprise artificial intelligence component(s) which can employ an artificial intelligence (AI) model, neural network or a neural network model, or machine learning or machine learning (ML) model, that can learn to perform the above or below described functions (e.g., via training data and/or feedback data).

In some embodiments, the system 100 and/or the DPA system 102 can include ML module 128 including an artificial intelligence (AI) and/or ML model that can be trained (e.g., via supervised and/or unsupervised techniques) to perform one or more of the above or below-described functions using training data including various context conditions that correspond to various management operations. In one example, an AI and/or ML model can further learn (e.g., via supervised and/or unsupervised techniques) to perform the above or below-described functions using training data including feedback data, where such feedback data can be collected and/or stored (e.g., in memory 118 or data source 104) by an ML module 128. In this example, such feedback data can include the various instructions described above/below that can be input, for instance, to a system herein, over time in response to observed/stored context-based information.

AI/ML components herein can initiate an operation(s) associated with the one or more functional components 120, 122, 124, 126 of the DPA system 102 based on a defined level of confidence determined using information (e.g., feedback data). For example, based on learning to perform such functions described above using feedback data, performance information, and/or past performance information herein, ML module 128 herein can initiate an operation associated with providing feature values as output predictions of key drivers based on input data applied to the model, the input data including at least one of streaming data or batch data. In another example, based on learning to perform such functions described above using feedback data, an ML module 128 herein can train a model from scratch, train a model using reinforcement learning for continual learning, or both.

In an embodiment, the ML module 128 can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an ML module 128 herein can perform classifications, correlations, inferences, and/or expressions associated with principles of artificial intelligence. For instance, an ML module 128 can employ an automatic classification system and/or an automatic classification. In one example, the ML module 128 can employ a probabilistic and/or statistical-based analysis (e.g., factoring into the analysis utilities and costs) to learn and/or generate inferences. The ML module 128 can employ any suitable machine-learning based techniques, statistical-based techniques and/or probabilistic-based techniques. For example, the ML module 128 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML module 128 can perform a set of machine-learning computations. For instance, the ML module 128 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In some embodiments, the ML module 128 can utilize one or more clustering techniques including, but not limited to, density-based clustering, distribution-based clustering, centroid-based clustering, hierarchical based clustering, or any combinations thereof. In addition, the one or more models can apply one or more clustering algorithms including, but not limited to, k-means clustering algorithms, density-based clustering algorithms, Gaussian mixture model algorithms, balanced iterative reducing and clustering using hierarchies (BIRCH) algorithms, propagation clustering algorithms, mean-shift clustering algorithms, order point clustering, agglomerative hierarchy clustering algorithms, other algorithms, or any combinations thereof. For example, the ML module 128 can apply the one or more centroid-based clustering models to determine clusters using k-means clustering algorithms.

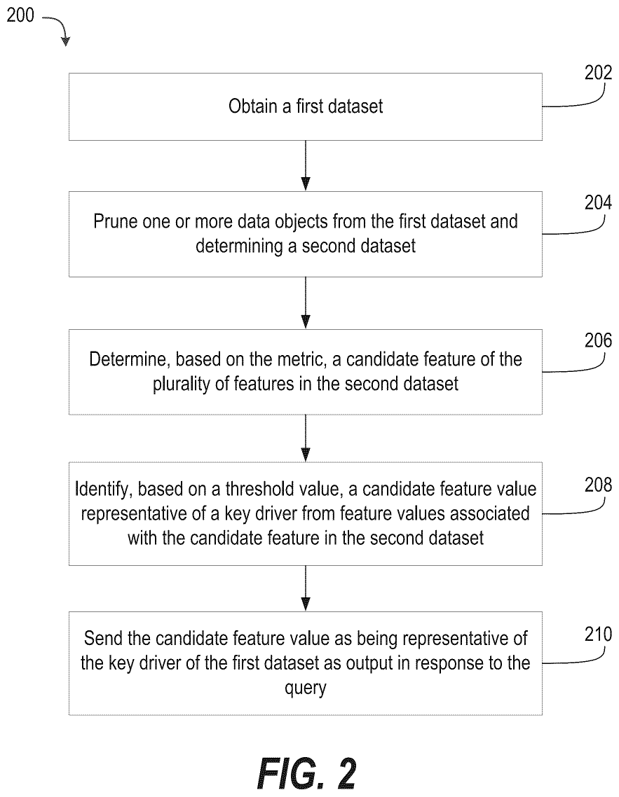

FIG. 2 is a flow diagram of an example method 200 for identifying a key driver of a dataset based on a metric, according to some embodiments. The method 200 can be performed by DPA system 102 in conjunction with data processing system 106, and thus may be computer-implemented.

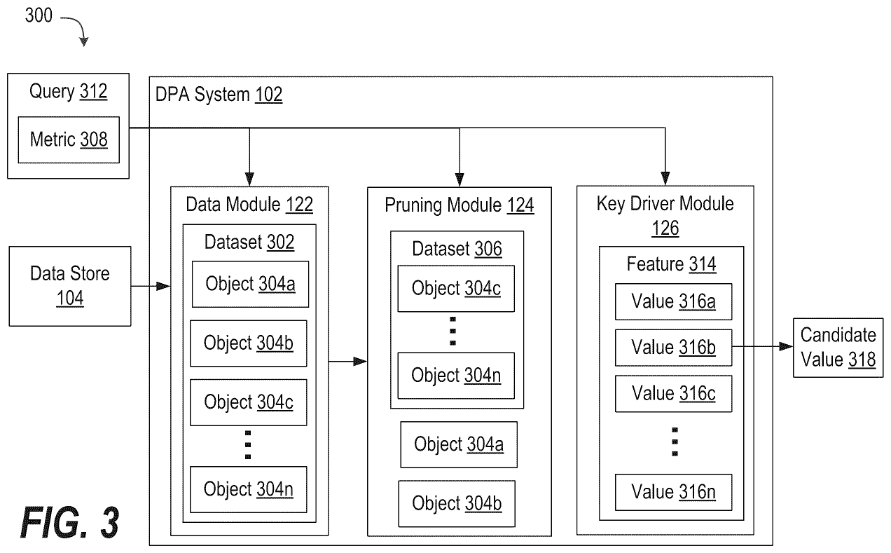

FIG. 3 is a block diagram of an example system 300 for performing the method 200 of FIG. 2, according to some embodiments. The method 200 will be described in conjunction with system 300.

At 202, the method 200 can include obtain a first dataset. The first dataset can include a plurality of data objects having associated therewith feature values for each of a plurality of features. In FIG. 2, the first dataset is shown as dataset 302 and the plurality of data objects are shown as data object 304a, 304b, 304c, through 304n.

The first dataset can be obtained based on a query. In some embodiments, the query can include the first dataset. In other embodiments, the query can include one or more parameters for the data, and the method 200 can include obtaining the first dataset from a dataset store. In FIG. 3, the data store is shown as data store 104, the query is shown as query 312, and the dataset 302 is shown as being obtained from data store 104.

At 204, the method 200 can include pruning one or more data objects of the plurality of data objects from the first dataset based on comparing feature values associated with each of the plurality of data objects to the metric. In some embodiments, pruning the one or more data objects of the plurality of data objects from the first dataset can further determining a second dataset. The second dataset can include a first set of data objects of the plurality of data objects having associated therewith feature values for the plurality of features. In this regard, in some examples, the first dataset can include an ordered list of data objects including a plurality of features (e.g., categorical features, numerical features, etc.), and each feature of the plurality of features can include feature values associated with each data object of the plurality of data objects. In some embodiments, the feature value can be qualitative value such as, for example, text data. In other embodiments, the feature value can be a quantitative value such as, for example, numerical data. In FIG. 3, the second dataset is shown as dataset 306, the pruned data objects are shown as object 304a, 304b, and the metric is shown as metric 308.

At 206, the method 200 can include determining, based on the metric, a candidate feature of the plurality of features in the second dataset. The candidate feature can be identified based on the respective feature values associated with each of the plurality of features, and a feature of the plurality of features being selected as the candidate feature based on the feature values associated with the feature and the metric. In FIG. 3, the candidate feature is shown as feature 314.

At 208, the method 200 can include identifying, based on a threshold value, a candidate feature value representative of a key driver from feature values associated with the candidate feature in the second dataset as a key driver of the dataset. In some embodiments, the candidate feature can include one or more feature values associated with each of the first set of data objects in the second dataset, and the candidate feature value can be a feature value of the one or more feature values that has an associated value that is greater than the threshold value. In some embodiments, the candidate feature can include one or more feature values associated with each of the first set of data objects in the second dataset, and the candidate feature value can be a feature value common to the one or more feature values having values associated therewith that is greater than the threshold value. In FIG. 3, the candidate feature is shown as feature 314, the one or more feature values is shown as values 316a, 316b, 316c, through 316n, and the candidate feature value is shown as candidate value 318.

In some embodiments, the model can be configured to identify the candidate feature and the candidate feature value representative of the key driver based on applying one of a plurality of search algorithms to the second dataset. In some embodiments, the model can be configured to identify the candidate feature and the candidate feature value representative of the key driver based on applying a greedy search algorithm to the second dataset.

At 210, the method 200 can include sending the candidate feature value as being representative of the key driver of the first dataset as output. In some embodiments, the candidate feature value can be sent as the key driver based on the metric. In some embodiments, the candidate feature value can be sent as the key driver in response to a value associated with the candidate feature value exceeding the metric. In some embodiments, the candidate feature value can be sent in response to the query based on the value associated with the candidate feature value exceeding the metric.

According to some embodiments, the method 200 can further include comparing the candidate feature value identified at operation 208 to the threshold value. In some embodiments, in response to the identified candidate feature value being below the threshold value, the method 200 can further include filtering out feature values previously identified as being representative of the key driver from the second dataset, further refining the second dataset in response to determining the candidate feature value is below the threshold value, and identifying at least one additional candidate feature value representative of the key driver from the refined second dataset. In some embodiments, comparing the candidate feature value to the threshold value can include identifying the one or more data objects having feature values corresponding to the identified candidate value in the candidate feature, and comparing one or more feature values for another feature associated with these same data objects to the threshold value, and in response to these one or more feature values of the other feature exceeding the threshold value, further refining the second dataset to identify the at least one additional candidate feature value.

In some embodiments, the further refining of the second dataset can include repeating at least one of the pruning, determining, or identifying steps using the second dataset to determine the at least one additional candidate feature value until the identified candidate feature value and the at least one additional candidate feature value exceeds the threshold value. That is, in some embodiments, the further refining of the second dataset can include repeating at least one of operations 204, 206, 208, 210 using the second dataset to determine the at least one additional candidate feature until the combined value associated with the at least one additional candidate feature exceeds the threshold value or exceeds the metric. For example, the identified candidate feature value can be a first feature value and the at least one additional candidate feature value can include a second feature value and a third feature value, that when combined exceeds the threshold value or the metric.

In some embodiments, comparing the candidate feature value to the metric or the threshold value can include comparing a numerical feature value associated with a same data object as the candidate feature value to the metric or the threshold value. In some embodiments, comparing the candidate feature value to the metric or the threshold value can include comparing a sum of the numerical feature values associated with the same data objects as the feature values from the candidate feature that matches the candidate feature value to the metric or to the threshold value.

The data objects in the dataset can be allocated to a respective bucket of a collection of buckets based on the feature value associated with each data object for the candidate feature. Once allocated, each bucket can include one or more data objects of the dataset allocated, each data object include the feature values for the categories of the dataset. In this regard, comparing the candidate feature value to the metric or the threshold value can include comparing the feature values associated with the one or more data objects allocated to a bucket of the collection of buckets having the candidate feature value. Accordingly, in some embodiments, for the data objects in the bucket corresponding to the identified candidate feature value, comparing the candidate feature value to the metric or the threshold value can include comparing the sum of the numerical feature values associated with the one or more data objects in the bucket to the metric or to the threshold value.

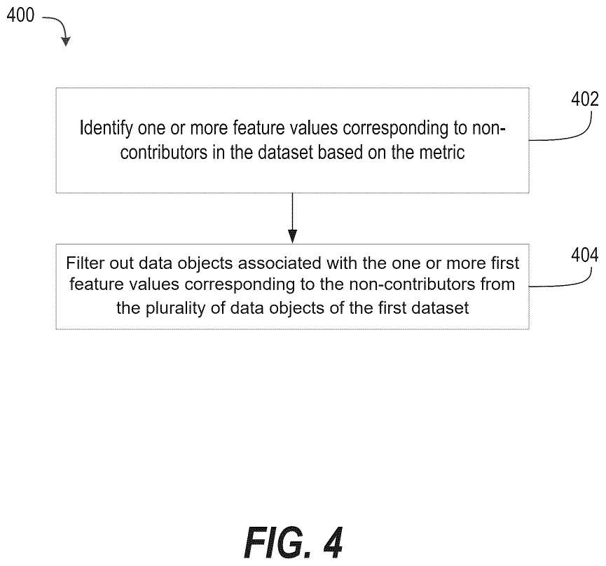

FIG. 4 is a flow diagram of an example method 400 for pruning feature values in a dataset, according to some embodiments. The method 400 may be an embodiment of operations 202 of the method 200 in FIG. 2. The method 200 can be performed by DPA system 102 in conjunction with data processing system 106, and thus may be computer-implemented.

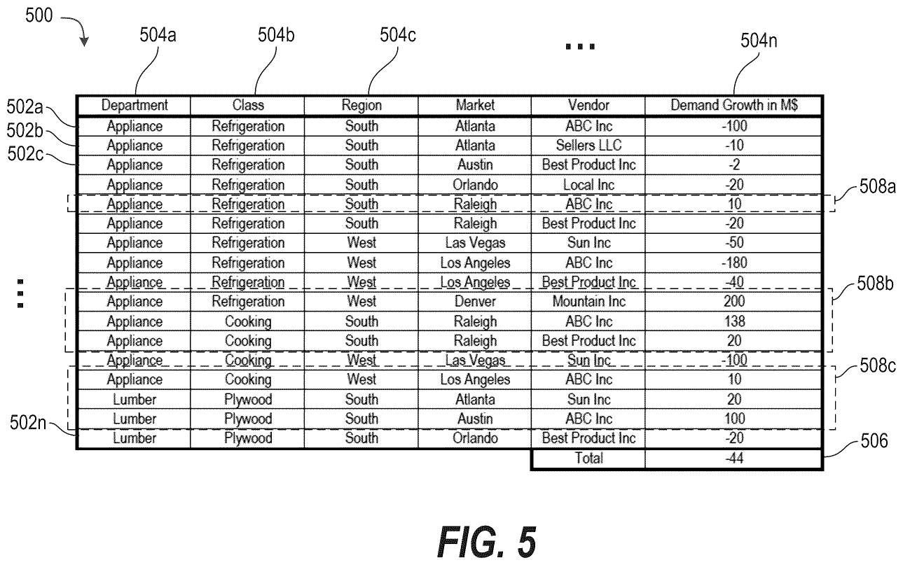

FIG. 5 is a graphical diagram of an example dataset 500 corresponding to a search space including a plurality of data objects and a plurality of feature values for a plurality of features, according to some embodiments. The dataset 500 can be an embodiment of dataset 302 in FIG. 3. The method 400 will be described in conjunction with the dataset 500.

At 402, the method 400 can include identifying one or more first feature values corresponding to non-contributors in the first dataset based on the metric. In some embodiments, the identified one or more first feature values can correspond only to those feature values in the dataset that are non-contributors in the dataset. In some embodiments, the one or more feature values corresponding to the non-contributors in the first dataset can be a first feature values of the plurality of features in the first dataset. In an example, the metric can be to determine what is driving an increase in completed electronic transactions in a dataset, and the feature values corresponding to non-contributors of the metric and that do not explain the increase in completed electronic transactions based on historical transaction data. In FIG. 5, the first dataset is shown as dataset 500, the plurality of data objects are shown as data objects 502a, 502b, 502c, through 502n, the plurality of features are shown as features 504a, 504b, 504c, through 504n, each of the plurality of data objects includes feature values associated therewith across the plurality of features 504a, 504b, 504c, through 504n, and the metric is shown as 506. In addition, in FIG. 5, the plurality of features is shown as being representative of a “Department,” “Class,” “Region,” “Market,” “Vendor,” and “Demand Growth in M$.”

In some embodiments, the dataset can include at least one numerical feature (e.g., column) and each data object of the plurality of data objects in the first dataset can include a numerical feature value associated therewith for the numerical feature. In addition, in some embodiments, the one or more feature values corresponding to the non-contributors can correspond to one or more numerical feature values from the numerical feature that do not contribute to explaining the key driver of change in the dataset based on the metric. In other embodiments, the dataset can include at least one categorical feature (e.g., column) and each data object of the plurality of data objects in the first dataset can include a categorical feature value associated therewith for the categorical feature, and the one or more feature values corresponding to the non-contributors can correspond to one or more categorical feature values from the categorical feature that do not contribute to explaining the key driver of change in the dataset based on the metric.

At 404, the method 400 can include filtering out data objects associated with the one or more first feature values corresponding to the non-contributors from the plurality of data objects of the first dataset. The one or more first feature values associated with the data objects filtered from the first dataset can include the feature values across the plurality of features that are associated with each of the data objects being filtered from the dataset. That is, once the feature values corresponding to non-contributors are identified in the dataset, the data object including the non-contributing feature value and the other feature values associated with the data object is filtered out of the dataset. In some embodiments, filtering the data objects based on being associated with the one or more first feature values corresponding to the non-contributors from the first dataset can include removing the one or more data objects from the search space of the first dataset. In FIG. 5, the filtered out data objects is shown as data objects 508a, 508b, and 508c.

In some embodiments, the second dataset can correspond to the data objects of the plurality of data objects of the first dataset that do not have associated therewith the one or more first feature values corresponding to the non-contributors. In some embodiments, the second dataset may not include the data objects associated with the one or more first feature values. In some embodiments, the first set of data objects of the second dataset may not include the data objects associated with the one or more first feature values.

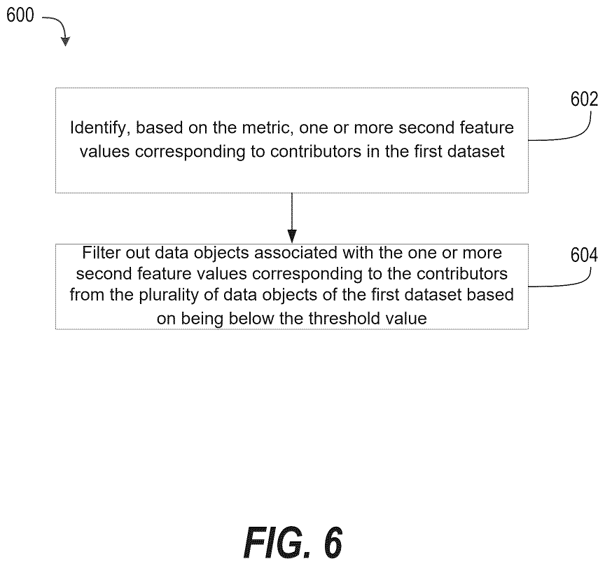

FIG. 6 is a flow diagram of an example method 600 for pruning feature values in a dataset, according to some embodiments. The method 600 may be an embodiment of operation 202 of the method 200 in FIG. 2 or an embodiment of operations 402, 404 of the method 400 in FIG. 4. The method 600 can be performed by DPA system 102 in conjunction with data processing system 106, and thus may be computer-implemented.

FIG. 7 is a graphical diagram of an example dataset 700 corresponding to a search space including a plurality of data objects and a plurality of feature values for a plurality of features, according to some embodiments. The dataset 700 may be an embodiment of dataset 500 in FIG. 5 or an embodiment of dataset 302 in FIG. 3. The method 600 will be described in conjunction with the dataset 700.

At 602, the method 600 can include identifying, based on the metric, one or more second feature values corresponding to contributors in the first dataset. In some embodiments, the identified one or more second feature values can correspond only to those feature values in the dataset that are contributors to the metric in the dataset. In some embodiments, the one or more feature values corresponding to the contributors in the first dataset can be a second feature values of the plurality of features in the first dataset. In some embodiments, the one or more feature values corresponding to the contributors in the first dataset can be identified based on comparing the one or more feature values to the metric. In an example, a feature value in a dataset is one that contributes to the metric for identifying goods or services that is driving growth but does not explain 30% of the increase. In FIG. 7, the first dataset is shown as dataset 700, the plurality of data objects is shown as data objects 702a, 702b, 702c, through 702n, the plurality of features is shown as features 704a, 704b, 704c, through 704n, each of the data objects 702a, 702b, 702c, through 702n is shown having associated therewith feature values across the features 704a, 704b, 704c, through 704n, and the metric is shown as metric 706.

In some embodiments, the dataset can include at least one numerical feature (e.g., column) and each data object of the plurality of data objects in the first dataset can include a numerical feature value associated therewith for the numerical feature. In addition, in some embodiments, the one or more feature values corresponding to contributors of the metric, but that do not exceed the threshold value can correspond to one or more numerical feature values from the numerical feature and that thereby do not contribute to explaining the key driver of change in the dataset based on the metric. In other embodiments, the dataset can include at least one categorical feature (e.g., column) and each data object of the plurality of data objects in the first dataset can include a categorical feature value associated therewith for the categorical feature, and the one or more feature values can correspond to one or more categorical feature values from the categorical feature that contributes to the metric, but that do not exceed the threshold value and thereby do not correspond to being a key driver of change in the dataset based on the metric.

At 604, the method 600 can include filtering out data objects associated with the one or more second feature values corresponding to the contributors from the plurality of data objects of the first dataset based on being below the threshold value. The data objects that are filtered from the first dataset can include the feature values across all the plurality of features including the one or more second feature values. That is, once the feature values corresponding to contributors are identified in the dataset, the data object including the contributing feature value and the other feature values associated with the data object is filtered out of the dataset. In some embodiments, filtering the data objects based on being associated with the one or more second feature values corresponding to the contributors from the first dataset can include removing the one or more data objects from the search space of the first dataset. In FIG. 7, the filtered out data objects is shown as data objects 708a, 708b, and 708c. In FIG. 7, for example, the feature value “Austin” in the “Market” category and the feature value “Best Product Inc” in the “Vendor” category are identified as contributors of the metric but having numerical values associated therewith that fall below a threshold value of 25% of the metric of −44. In an example, the metric can be to determine what is driving an increase in completed electronic transactions in a dataset, and the feature values corresponding to contributors of the metric can include those feature values in the dataset that contribute to the metric but that do not explain the increase in completed electronic transactions based on the one or more feature values being less than the threshold value.

In some embodiments, the second dataset can correspond to the data objects of the plurality of data objects of the first dataset that do not have associated therewith the one or more second feature values corresponding to the contributors. In some embodiments, the second dataset may not include the data objects associated with the one or more second feature values. In some embodiments, the first set of data objects of the second dataset may not include the data objects associated with the one or more second feature values.

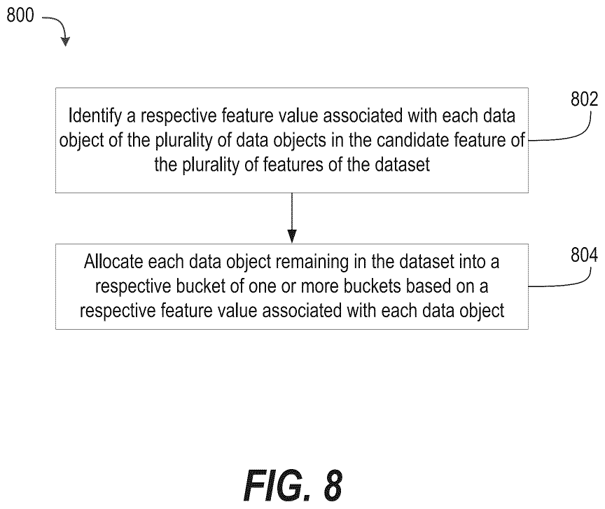

FIG. 8 is a flow diagram of an example method 800 for identifying a key driver in a dataset, according to some embodiments. The method 800 may be an embodiment of operations 202, 204 of the method 200 in FIG. 2, an embodiment of operations 402, 404 of the method 400 in FIG. 4, or an embodiment of operations 602, 604 of the method 600 in FIG. 6. The method 800 can be performed by DPA system 102 in conjunction with data processing system 106, and thus may be computer-implemented.

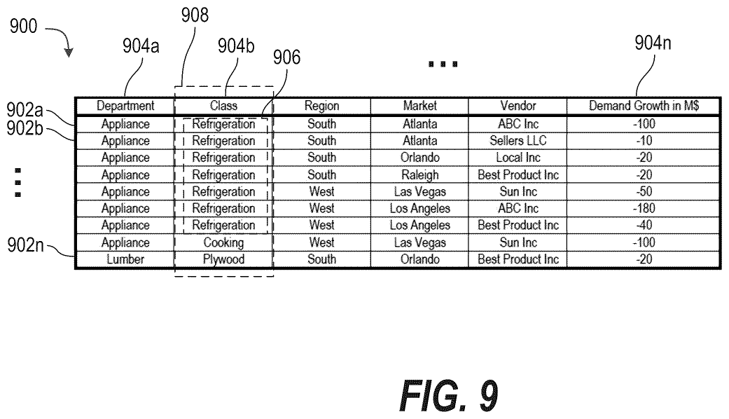

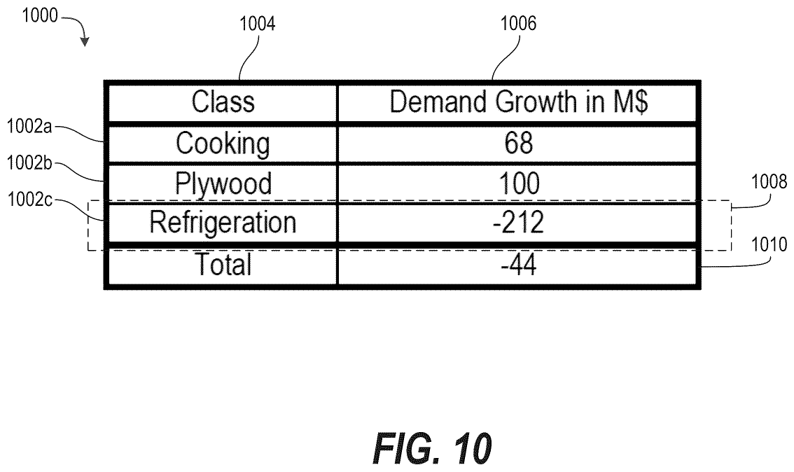

FIG. 9 is a graphical diagram of an example dataset 900, according to some embodiments. The dataset 900 may be an embodiment of method 800. FIG. 10 is a graphical diagram illustrating an example dataset 1000, according to some embodiments. The dataset 1000 may be an embodiment of method 800. The method 800 will be described in conjunction with the dataset 900 and the dataset 1000.

At 802, the method 800 can include identifying a feature value associated with each data object of the first set of data objects for the candidate feature in the second dataset. In FIG. 9, the second dataset is shown as dataset 900, the first set of data objects is shown as data objects 902a, 902b, through 902n, features 904a, 904b, through 904n, the plurality of features is shown as features 904a, 904b, through 904n, and the candidate feature is shown as feature 908.

At 804, the method 800 can include classifying each data object of the first set of data objects based on the feature value associated with each data object of the first set of data objects for the candidate feature. In some embodiments, classifying the data objects can include grouping data objects having a common feature value at the candidate feature with other data objects of the first set of data objects. In FIG. 9, the data objects classified as having a common feature value is shown at block 906. In FIG. 10, the groupings are shown as groups 1002a, 1002b, 1002c, the candidate feature is shown as feature 1004, and each of the groups 1002a, 1002b, 1002c includes numerical features shown as feature 1006.

In some embodiments, classifying each data object can include allocating each data object of the one or more data objects of the second dataset into a respective bucket of a collection of buckets based on the feature value at the candidate feature associated with each data object. Each bucket of the collection of buckets can be representative of a common feature value of the one or more features in the candidate feature and can include one or more data objects of the second dataset allocated thereto.

At 906, the method 900 can include filtering out one or more data objects from the first set of data objects of the second dataset based on the candidate feature value. In some embodiments, filtering out the one or more data objects can include determining a third dataset. In some embodiments, the third dataset can include a second set of data objects having associated therewith feature values for the plurality of features that are remaining after filtering the one or more data objects from the first set of data objects of the second dataset. In some embodiments, the one or more data objects filtered from the first set of data objects can have feature values at the candidate feature that does not match the candidate feature value. In this regard, the data objects having associated therewith any feature value other than the identified candidate feature value at the candidate feature can be filtered from the second dataset to determine the third dataset. In FIG. 9, the filtered data objects are shown as having feature values at candidate feature 908 that do not match the candidate feature value 906. In FIG. 10, the candidate feature value is shown at block 1008, which is identified based on the feature value associated with the group 1002c having a value that exceeds the metric shown as metric 1010.

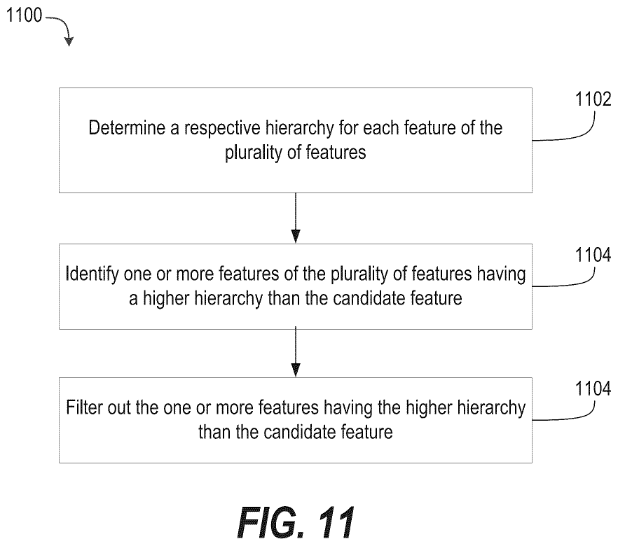

FIG. 11 is a flow diagram of a non-limiting example of a method 1100 for pruning features in a dataset, according to some embodiments. The method 1100 may be an embodiment of operation 206 of the method 200 in FIG. 2. The method 1100 can be performed by DPA system 102 in conjunction with data processing system 106, and thus may be computer-implemented.

At 1102, the method 1100 can include determining a respective hierarchy of each feature of the plurality of features.

At 1104, the method 1100 can include identifying one or more features of the plurality of features having a higher hierarchy than the candidate feature value. In some embodiments, the hierarchy of each feature of the plurality of features can be determined based on the feature values associated with each feature. Accordingly, in some embodiments, the features having a higher hierarchy than the candidate feature value can be determined based on the corresponding feature values associated with each feature.

At 1106, the method 1100 can include filtering out the one or more features having the higher hierarchy than the candidate feature. In some embodiments, the filtering can include filtering out one or more of the features at the one or more features having the higher hierarchy than the identified candidate feature value at the candidate feature. In FIG. 9, for example, feature 904a has a higher hierarchy than feature 904b, and the feature 904a can be filtered from the dataset 900.

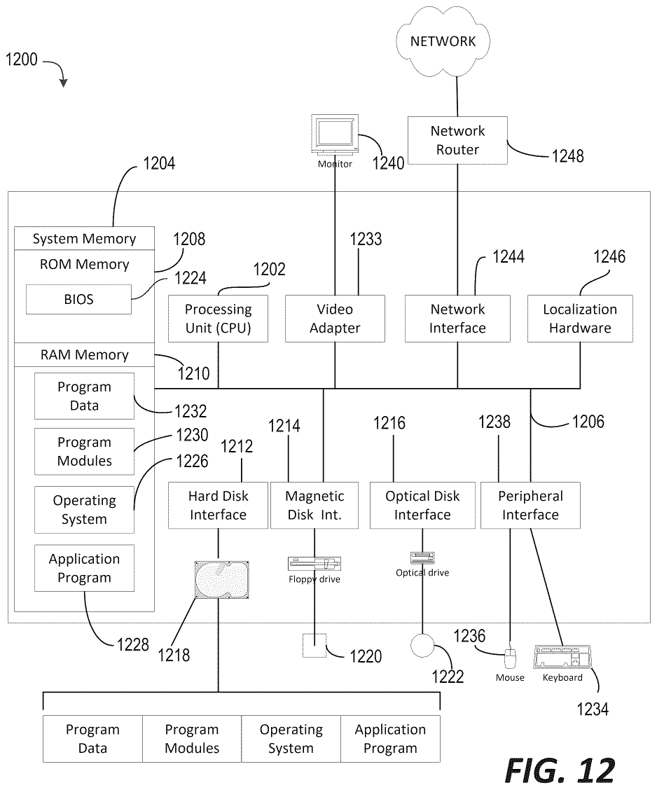

FIG. 12 is a block diagram of an example computing system, such as a desktop computer, laptop, smartphone, tablet, or any other such device having the ability to execute instructions, such as those stored within a non-transient, computer-readable medium. Furthermore, while described and illustrated in the context of a single computing system 1200, those skilled in the art will also appreciate that the various tasks described hereinafter may be practiced in a distributed environment having multiple computing systems 1200 linked via a local or wide-area network in which the executable instructions may be associated with and/or executed by one or more of multiple computing systems 1200. In a non-limiting example, the system 100 in FIG. 1 can be associated with an entity and can include multiple computing systems 1200 including a computing system 1200 located at each retail location of the entity, a computing system 1200 including DPA system 102, and a computing system 1200 including data processing system 106.

In its most basic configuration, computing system environment 1200 typically includes at least one processing unit 1202 and at least one memory 1204, which may be linked via a bus 1206. Depending on the exact configuration and type of computing system environment, memory 1204 may be volatile (such as RAM 1210), non-volatile (such as ROM 1208, flash memory, etc.) or some combination of the two. Computing system environment 1200 may have additional features and/or functionality. For example, computing system environment 1200 may also include additional storage (removable and/or non-removable) including, but not limited to, magnetic or optical disks, tape drives and/or flash drives. Such additional memory devices may be made accessible to the computing system environment 1200 by means of, for example, a hard disk drive interface 1212, a magnetic disk drive interface 1214, and/or an optical disk drive interface 1216. As will be understood, these devices, which would be linked to the system bus 1206, respectively, allow for reading from and writing to a hard disk 1218, reading from or writing to a removable magnetic disk 1220, and/or for reading from or writing to a removable optical disk 1222, such as a CD/DVD ROM or other optical media. The drive interfaces and their associated computer-readable media allow for the nonvolatile storage of computer readable instructions, data structures, program modules and other data for the computing system environment 1200. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 1200.

A number of program modules may be stored in one or more of the memory/media devices. For example, a basic input/output system (BIOS) 1224, containing the basic routines that help to transfer information between elements within the computing system environment 1200, such as during start-up, may be stored in ROM 1208. Similarly, RAM 1210, hard drive 1218, and/or peripheral memory devices may be used to store computer executable instructions comprising an operating system 1226, one or more applications programs 1228, other program modules 1230, and/or program data 1232. Still further, computer-executable instructions may be downloaded to the computing environment 1200 as needed, for example, via a network connection. The applications programs 1228 may include, for example, a browser, including a particular browser application and version, which browser application and version may be relevant to determinations of correspondence between communications and user URL requests, as described herein. Similarly, the operating system 1226 and its version may be relevant to determinations of correspondence between communications and user URL requests, as described herein.

An end-user may enter commands and information into the computing system environment 1200 through input devices such as a keyboard 1234 and/or a pointing device 1236. While not illustrated, other input devices may include a microphone, a joystick, a game pad, a scanner, etc. These and other input devices would typically be connected to the processing unit 1202 by means of a peripheral interface 1238 which, in turn, would be coupled to bus 1206. Input devices may be directly or indirectly connected to processor 1202 via interfaces such as, for example, a parallel port, game port, firewire, or a universal serial bus (USB). To view information from the computing system environment 1200, a monitor 1240 or other type of display device may also be connected to bus 1206 via an interface, such as via video adapter 1233. In addition to the monitor 1240, the computing system environment 1200 may also include other peripheral output devices, not shown, such as speakers and printers.

The computing system environment 1200 may also utilize logical connections to one or more computing system environments. Communications between the computing system environment 1200 and the remote computing system environment may be exchanged via a further processing device, such a network router 1248, that is responsible for network routing. Communications with the network router 1248 may be performed via a network interface component 1244. Thus, within such a networked environment, e.g., the Internet, World Wide Web, LAN, or other like type of wired or wireless network, it will be appreciated that program modules depicted relative to the computing system environment 1200, or portions thereof, may be stored in the memory storage device(s) of the computing system environment 1200.

The computing system environment 1200 may also include localization hardware 1246 for determining a location of the computing system environment 1200. In embodiments, the localization hardware 1246 may include, for example only, a GPS antenna, an RFID chip or reader, a WiFi antenna, or other computing hardware that may be used to capture or transmit signals that may be used to determine the location of the computing system environment 1200. Data from the localization hardware 1246 may be included in a callback request or other user computing device metadata in the methods of this disclosure.

The computing system, or one or more portions thereof, may embody a user computing device 108, in some embodiments. Additionally, or alternatively, some components of the computing system 1200 may embody the DPA system 102 and/or data processing system 106. For example, the functional modules 128, 120, 122, 124, 126, 128 may be embodied as program modules 1230.

In some embodiments, a computer-implemented method for identifying key drivers of a dataset based on a metric defined in a query includes obtaining a first dataset based on the query, the first dataset including a plurality of data objects having associated therewith feature values for each of a plurality of features; pruning, by a model, one or more data objects of the plurality of data objects from the first dataset based on comparing feature values associated with each of the plurality of data objects to the metric and determining a second dataset, the second dataset including a first set of data objects of the plurality of data objects having associated therewith feature values for the plurality of features; determining, by the model based on the metric, a candidate feature of the plurality of features in the second dataset; identifying, by the model based on a threshold value, a candidate feature value representative of a key driver from feature values associated with the candidate feature in the second dataset; and sending the candidate feature value as being representative of the key driver of the first dataset as output in response to the query, the metric including the threshold value.

In some embodiments, according to the computer-implemented method, pruning the one or more data objects of the plurality of data objects from the first dataset based on comparing the feature values associated with each of the plurality of data objects to the metric includes identifying, based on the metric, one or more first feature values corresponding to non-contributors in the first dataset; and filtering out data objects associated with the one or more first feature values corresponding to the non-contributors from the plurality of data objects of the first dataset, the second dataset does not include the data objects associated with the one or more first feature values.

In some embodiments, according to the computer-implemented method, pruning the one or more data objects from the first dataset based on the feature values associated with the one or more data objects includes: identifying, based on the metric, one or more second feature values corresponding to contributors in the first dataset; and filtering out data objects associated with the one or more second feature values corresponding to the contributors from the plurality of data objects of the first dataset based on being below the threshold value, the second dataset does not include the data objects associated with the one or more second feature values.

In some embodiments, according to the computer-implemented method, identifying the candidate feature value further includes: identifying, by the model, a feature value associated with each data object of the first set of data objects for the candidate feature in the second dataset; classifying, by the model, each data object of the first set of data objects based on the feature value associated with each data object of the first set of data objects for the candidate feature; and filtering out, by the model, one or more data objects from the first set of data objects of the second dataset based on the candidate feature value and determining a third dataset, the third dataset including a second set of data objects having associated therewith feature values for the plurality of features.

In some embodiments, according to the computer-implemented method, the method further includes: determining a respective hierarchy of each feature of the plurality of features; identifying one or more features of the plurality of features having a higher hierarchy than the candidate feature; and filtering out the one or more features having the higher hierarchy than the candidate feature.

In some embodiments, according to the computer-implemented method, the method further includes: comparing the candidate feature value to the threshold value; filtering out, by the model, feature values previously identified as being representative of the key driver from the second dataset; further refining, by the model, the second dataset in response to determining the candidate feature value is below the threshold value; and identifying at least one additional candidate feature value representative of the key driver from the refined second dataset, wherein the further refining of the second dataset includes repeating at least one of the pruning, determining, or identifying steps using the second dataset to determine the at least one additional candidate feature value until the identified candidate feature value and the at least one additional candidate feature value exceeds the threshold value.

In some embodiments, according to the computer-implemented method, the model is configured to identify the candidate feature and the candidate feature value representative of the key driver based on applying one of a plurality of search algorithms to the second dataset.

In some embodiments, according to the computer-implemented method, the model is configured to identify the candidate feature and the candidate feature value representative of the key driver based on applying a greedy search algorithm to the second dataset.

In some embodiments, a system includes: a processor; and a non-transitory computer readable media having stored thereon instructions executable by the processor to perform operations including: obtain a first dataset including a plurality of data objects having associated therewith feature values for each of a plurality of features; prune one or more data objects of the plurality of data objects from the first dataset based on comparing feature values associated with each of the plurality of data objects to a metric and determining a second dataset including a first set of data objects of the plurality of data objects having associated therewith feature values for the plurality of features; determine, based on the metric, a candidate feature of the plurality of features in the second dataset; identify, based on the metric, a candidate feature value representative of a key driver from feature values associated with the candidate feature in the second dataset; prune one or more features from the second dataset based on the identified candidate feature value; and send the candidate feature value as being representative of the key driver of the first dataset as output, the metric including a threshold value.

In some embodiments, according to the system, pruning the one or more data objects of the plurality of data objects from the first dataset based on comparing the feature values associated with each of the plurality of data objects to the metric includes: identify, based on the metric, one or more first feature values corresponding to non-contributors in the first dataset; filter out data objects associated with the one or more first feature values corresponding to the non-contributors from the plurality of data objects of the first dataset, identify, based on the metric, one or more second feature values corresponding to contributors in the first dataset, and filter out data objects associated with the one or more second feature values corresponding to the contributors from the plurality of data objects of the first dataset based on being below the threshold value, the second dataset does not include the data objects associated with the one or more second feature values and the data objects associated with the one or more first feature values.

In some embodiments, according to the system, identifying the candidate feature value in the second dataset based on the metric further includes: identify a feature value associated with each data object of the first set of data objects for the candidate feature in the second dataset; classify each data object of the first set of data objects based on the feature value associated with each data object of the first set of data objects for the candidate feature; and filter out one or more data objects from the first set of data objects of the second dataset based on the candidate feature value and determining a third dataset, the third dataset including a second set of data objects having associated therewith feature values for the plurality of features.

In some embodiments, according to the system, pruning the one or more features from the second dataset based on the identified candidate feature value includes: determine a respective hierarchy of each feature of the plurality of features; identify the one or more features of the plurality of features having a higher hierarchy than the candidate feature; and filter out the one or more features having the higher hierarchy than the candidate feature.

In some embodiments, according to the system, the operations further includes: compare the candidate feature value to the threshold value; filter out feature values previously identified as being representative of the key driver from the second dataset; further refine the second dataset in response to determining the candidate feature value is below the threshold value; and identify at least one additional candidate feature value representative of the key driver from the refined second dataset, wherein the refining of the second dataset includes repeating at least one of the pruning, determining, or identifying steps on the second dataset to determine the at least one additional candidate feature until the identified candidate feature value and the at least one additional candidate feature value exceeds the threshold value.

In some embodiments, according to the system, the candidate feature and the candidate feature value representative of the key driver are identified based on applying one of a plurality of search algorithms to the second dataset.

In some embodiments, according to the system, the candidate feature and the candidate feature value representative of the key driver are identified based on applying a greedy search algorithm to the second dataset.

In some embodiments, a non-transitory computer-program product having stored thereon instructions executable by a processor of a computing device to perform operations includes: obtain a first dataset including a plurality of data objects having associated therewith feature values for each of a plurality of features; prune, by a model, one or more data objects of the plurality of data objects from the first dataset based on comparing feature values associated with each of the plurality of data objects to a metric and determining a second dataset including a first set of data objects of the plurality of data objects having associated therewith feature values for the plurality of features; determine, by the model based on the metric, a candidate feature of the plurality of features in the second dataset; identify, by the model applying a search algorithm to the second dataset and based on the metric, a candidate feature value representative of a key driver from feature values associated with the candidate feature in the second dataset; compare the candidate feature value to a threshold value; in response to the candidate feature value exceeding the threshold value, send the candidate feature value as being representative of the key driver of the first dataset as output; and in response to determining the candidate feature value is below the threshold value, the operations further include: filter out, by the model, feature values previously identified as being representative of the key driver from the second dataset; further refine, by the model, the second dataset in response to determining the candidate feature value is below the threshold value; and identify at least one additional candidate feature value representative of the key driver from the refined second dataset, wherein the refining of the second dataset includes repeating at least one of the pruning, determining, or identifying steps on the second dataset to determine the at least one additional candidate feature until the identified candidate feature value and the at least one additional candidate feature value exceeds the threshold value; wherein the metric includes the threshold value.

In some embodiments, according to the non-transitory computer-program product, pruning the one or more data objects of the plurality of data objects from the first dataset based on comparing the feature values associated with each of the plurality of data objects to the metric includes: identify, based on the metric, one or more first feature values corresponding to non-contributors in the first dataset; filter out data objects associated with the one or more first feature values corresponding to the non-contributors from the plurality of data objects of the first dataset; identify, based on the metric, one or more second feature values corresponding to contributors in the first dataset; and filter out data objects associated with the one or more second feature values corresponding to the contributors from the plurality of data objects of the first dataset based on being below the threshold value, the second dataset does not include the data objects associated with the one or more second feature values and the data objects associated with the one or more first feature values.

In some embodiments, according to the non-transitory computer-program product, identifying the candidate feature value in the second dataset based on the metric further includes: identify a feature value associated with each data object of the first set of data objects for the candidate feature in the second dataset; classify each data object of the first set of data objects based on the feature value associated with each data object of the first set of data objects for the candidate feature; and filter out, by the model, one or more data objects from the first set of data objects of the second dataset based on the candidate feature value and determining a third dataset, the third dataset including a second set of data objects having associated therewith feature values for the plurality of features.

In some embodiments, according to the non-transitory computer-program product, the operations further includes: determine a respective hierarchy of each feature of the plurality of features; identify one or more features of the plurality of features having a higher hierarchy than the candidate feature; and filter out the one or more features having the higher hierarchy than the candidate feature.

In some embodiments, according to the non-transitory computer-program product, the candidate feature and the candidate feature value representative of the key driver are identified based on applying a greedy search algorithm to the second dataset.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A computer-implemented method for identifying key drivers of a dataset based on a metric defined in a query, the method comprising:
obtaining a first dataset based on the query, the first dataset comprising a plurality of data objects having associated therewith feature values for each of a plurality of features;
pruning, by a model, one or more data objects of the plurality of data objects from the first dataset based on comparing feature values associated with each of the plurality of data objects to the metric and determining a second dataset, the second dataset comprising a first set of data objects of the plurality of data objects having associated therewith feature values for the plurality of features;
determining, by the model based on the metric, a candidate feature of the plurality of features in the second dataset;
identifying, by the model based on a threshold value, a candidate feature value representative of a key driver from feature values associated with the candidate feature in the second dataset; and
sending the candidate feature value as being representative of the key driver of the first dataset as output in response to the query,
wherein the metric comprises the threshold value.

2. The computer-implemented method of claim 1, wherein pruning the one or more data objects of the plurality of data objects from the first dataset based on comparing the feature values associated with each of the plurality of data objects to the metric comprises:
identifying, based on the metric, one or more first feature values corresponding to non-contributors in the first dataset; and
filtering out data objects associated with the one or more first feature values corresponding to the non-contributors from the plurality of data objects of the first dataset,
wherein the second dataset does not include the data objects associated with the one or more first feature values.

3. The computer-implemented method of claim 2, wherein pruning the one or more data objects from the first dataset based on the feature values associated with the one or more data objects comprises:
identifying, based on the metric, one or more second feature values corresponding to contributors in the first dataset; and
filtering out data objects associated with the one or more second feature values corresponding to the contributors from the plurality of data objects of the first dataset based on being below the threshold value,
wherein the second dataset does not include the data objects associated with the one or more second feature values.

4. The computer-implemented method of claim 1, wherein identifying the candidate feature value further comprises:
identifying, by the model, a feature value associated with each data object of the first set of data objects for the candidate feature in the second dataset;
classifying, by the model, each data object of the first set of data objects based on the feature value associated with each data object of the first set of data objects for the candidate feature; and
filtering out, by the model, one or more data objects from the first set of data objects of the second dataset based on the candidate feature value and determining a third dataset, the third dataset comprising a second set of data objects having associated therewith feature values for the plurality of features.

5. The computer-implemented method of claim 1, the method further comprising:
determining a respective hierarchy of each feature of the plurality of features;
identifying one or more features of the plurality of features having a higher hierarchy than the candidate feature; and
filtering out the one or more features having the higher hierarchy than the candidate feature.

6. The computer-implemented method of claim 5, the method further comprising:
comparing the candidate feature value to the threshold value;
filtering out, by the model, feature values previously identified as being representative of the key driver from the second dataset;
further refining, by the model, the second dataset in response to determining the candidate feature value is below the threshold value; and
identifying at least one additional candidate feature value representative of the key driver from the refined second dataset,
wherein the further refining of the second dataset comprises repeating at least one of the pruning, determining, or identifying steps using the second dataset to determine the at least one additional candidate feature value until the identified candidate feature value and the at least one additional candidate feature value exceeds the threshold value.

7. The computer-implemented method of claim 1, wherein the model is configured to identify the candidate feature and the candidate feature value representative of the key driver based on applying one of a plurality of search algorithms to the second dataset.

8. The computer-implemented method of claim 1, wherein the model is configured to identify the candidate feature and the candidate feature value representative of the key driver based on applying a greedy search algorithm to the second dataset.

9. A system comprising:
a processor; and
a non-transitory computer readable media having stored thereon instructions executable by the processor to perform operations comprising:
obtain a first dataset comprising a plurality of data objects having associated therewith feature values for each of a plurality of features;
prune one or more data objects of the plurality of data objects from the first dataset based on comparing feature values associated with each of the plurality of data objects to a metric and determining a second dataset comprising a first set of data objects of the plurality of data objects having associated therewith feature values for the plurality of features;
determine, based on the metric, a candidate feature of the plurality of features in the second dataset;
identify, based on the metric, a candidate feature value representative of a key driver from feature values associated with the candidate feature in the second dataset;
prune one or more features from the second dataset based on the identified candidate feature value; and
send the candidate feature value as being representative of the key driver of the first dataset as output,
wherein the metric comprises a threshold value.

10. The system of claim 9, wherein pruning the one or more data objects of the plurality of data objects from the first dataset based on comparing the feature values associated with each of the plurality of data objects to the metric comprises:
identify, based on the metric, one or more first feature values corresponding to non-contributors in the first dataset;
filter out data objects associated with the one or more first feature values corresponding to the non-contributors from the plurality of data objects of the first dataset,
identify, based on the metric, one or more second feature values corresponding to contributors in the first dataset, and
filter out data objects associated with the one or more second feature values corresponding to the contributors from the plurality of data objects of the first dataset based on being below the threshold value,
wherein the second dataset does not include the data objects associated with the one or more second feature values and the data objects associated with the one or more first feature values.

11. The system of claim 9, wherein identifying the candidate feature value in the second dataset based on the metric further comprises:
identify a feature value associated with each data object of the first set of data objects for the candidate feature in the second dataset;
classify each data object of the first set of data objects based on the feature value associated with each data object of the first set of data objects for the candidate feature; and
filter out one or more data objects from the first set of data objects of the second dataset based on the candidate feature value and determining a third dataset, the third dataset comprising a second set of data objects having associated therewith feature values for the plurality of features.

12. The system of claim 9, wherein pruning the one or more features from the second dataset based on the identified candidate feature value comprises:
determine a respective hierarchy of each feature of the plurality of features;
identify the one or more features of the plurality of features having a higher hierarchy than the candidate feature; and
filter out the one or more features having the higher hierarchy than the candidate feature.

13. The system of claim 9, the operations further comprising:
compare the candidate feature value to the threshold value;
filter out feature values previously identified as being representative of the key driver from the second dataset;
further refine the second dataset in response to determining the candidate feature value is below the threshold value; and
identify at least one additional candidate feature value representative of the key driver from the refined second dataset,
wherein the refining of the second dataset comprises repeating at least one of the pruning, determining, or identifying steps on the second dataset to determine the at least one additional candidate feature until the identified candidate feature value and the at least one additional candidate feature value exceeds the threshold value.

14. The system of claim 9, wherein the candidate feature and the candidate feature value representative of the key driver are identified based on applying one of a plurality of search algorithms to the second dataset.

15. The system of claim 9, wherein the candidate feature and the candidate feature value representative of the key driver are identified based on applying a greedy search algorithm to the second dataset.

16. A non-transitory computer-program product having stored thereon instructions executable by a processor of a computing device to perform operations comprising:
obtain a first dataset comprising a plurality of data objects having associated therewith feature values for each of a plurality of features;
prune, by a model, one or more data objects of the plurality of data objects from the first dataset based on comparing feature values associated with each of the plurality of data objects to a metric and determining a second dataset comprising a first set of data objects of the plurality of data objects having associated therewith feature values for the plurality of features;
determine, by the model based on the metric, a candidate feature of the plurality of features in the second dataset;
identify, by the model applying a search algorithm to the second dataset and based on the metric, a candidate feature value representative of a key driver from feature values associated with the candidate feature in the second dataset;
compare the candidate feature value to a threshold value;
in response to the candidate feature value exceeding the threshold value, send the candidate feature value as being representative of the key driver of the first dataset as output; and
in response to determining the candidate feature value is below the threshold value, the operations further comprise:
filter out, by the model, feature values previously identified as being representative of the key driver from the second dataset;
further refine, by the model, the second dataset in response to determining the candidate feature value is below the threshold value; and
identify at least one additional candidate feature value representative of the key driver from the refined second dataset,
wherein the refining of the second dataset comprises repeating at least one of the pruning, determining, or identifying steps on the second dataset to determine the at least one additional candidate feature until the identified candidate feature value and the at least one additional candidate feature value exceeds the threshold value;
wherein the metric comprises the threshold value.

17. The non-transitory computer-program product of claim 16, wherein pruning the one or more data objects of the plurality of data objects from the first dataset based on comparing the feature values associated with each of the plurality of data objects to the metric comprises:
identify, based on the metric, one or more first feature values corresponding to non-contributors in the first dataset;
filter out data objects associated with the one or more first feature values corresponding to the non-contributors from the plurality of data objects of the first dataset;
identify, based on the metric, one or more second feature values corresponding to contributors in the first dataset; and
filter out data objects associated with the one or more second feature values corresponding to the contributors from the plurality of data objects of the first dataset based on being below the threshold value,
wherein the second dataset does not include the data objects associated with the one or more second feature values and the data objects associated with the one or more first feature values.

18. The non-transitory computer-program product of claim 16, wherein identifying the candidate feature value in the second dataset based on the metric further comprises:
identify a feature value associated with each data object of the first set of data objects for the candidate feature in the second dataset;
classify each data object of the first set of data objects based on the feature value associated with each data object of the first set of data objects for the candidate feature; and
filter out, by the model, one or more data objects from the first set of data objects of the second dataset based on the candidate feature value and determining a third dataset, the third dataset comprising a second set of data objects having associated therewith feature values for the plurality of features.

19. The non-transitory computer-program product of claim 16, the operations further comprising:
determine a respective hierarchy of each feature of the plurality of features;
identify one or more features of the plurality of features having a higher hierarchy than the candidate feature; and
filter out the one or more features having the higher hierarchy than the candidate feature.

20. The non-transitory computer-program product of claim 16, wherein the candidate feature and the candidate feature value representative of the key driver are identified based on applying a greedy search algorithm to the second dataset.
